(19) United States
(12) Patent Application Publication
(10) Pub. No.: US 2005/0071352 A1
(43) Pub. Date: Mar. 31, 2005

(54) System and method for association itemset analysis

(76) Inventor: Chang-Hung Lee, Yunlin (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/952,318

(22) Filed: Sep. 28, 2004

(30) Foreign Application Priority Data
Sep. 29, 2003 (TW) 92126806

(51) Int. Cl. G06F 17/00

(52) U.S. Cl. 707/100

(57) ABSTRACT

A system for association itemset analysis. The system includes a storage device and an association analysis unit. All transaction records are partitioned according to time scale, each comprising at least one transaction item. The association analysis unit calculates multiple weighted minimum support values, generates multiple association itemsets among the transaction data stored in the storage device, and calculates frequency for each association itemset. In addition, it is determined whether the frequency for each itemset exceeds the weighted minimum support value to generate the resulting association itemset.

### BACKGROUND OF THE INVENTION

1. Field of the Invention

The present invention relates to data mining systems, and more particularly, to a method and system of time-constraint association itemset mining used in data mining systems.

2. Description of the Related Art

The discovery of association relationship among items in large databases has proven useful in selective marketing, decision analysis and business management. A popular area of applications is market basket analysis, which studies the buying behavior of customers by searching for sets of items frequently purchased either together or in sequence. Recently, association itemset mining has been applied to web browsing behavior and stock transaction analysis.

For a given support threshold, the object of association mining identifies all associations that have supported greater than the corresponding minimum support (denoted as min_supp) threshold. Association itemset mining algorithms have worked in generating all frequent itemsets that satisfy min_supp value.

One limitation is the time-consuming generation of associated items using conventional association mining from a database processing millions of transactions. In spite of this limitation, it is often argued that the association mining process may produce thousands of association relationships, some of which are useless and many of which are already known. Associated items generated by complicated conventional mining techniques always produced poor contributions to knowledge advancement.

Hence, several applications have been developed for use in constrained data mining. Specifically, constraint-based mining is performed under the guidance of various constraints provided by the operator. The constraints addressed in the prior work include knowledge constraints, data constraints, interestingness constraints, and rule constraints. Such constraints may be expressed as meta-rules (rule templates), as the maximum or minimum number of predicates that can occur in the antecedent or consequent rule, or as relationships among attributes, attribute values, and/or aggregates.

Although the constraint-based mining described above allows specification of rules for mining according to particular needs, thereby yielding more useful results, several problems remain. For example, most databases are time-variant databases, consisting of values or events that vary based on time. Constraint-based association rule mining, however, is not capable of efficiently handling time-variant databases due to problems such as not considering the exhibition period of individual transactions and lack of an intelligent support calculation basis for each item. Note that the conventional mining process treats transactions in different time periods indifferently and handles them with the same procedure, and is thus, unable to discover important -association items and thoroughly remove unnecessary association items.

For example, a popular itemset of A milk and B bread may be frequently purchased together, but if A milk stopped selling due to recent competitiveness, the association A milk and B bread is no longer useful, despite being yielded by conventional association mining techniques over a one-year transaction period. In addition, C milk may have been active recently, individually as well as in association with D bread. C milk and D bread thus constitute a significant association for selective market decision making, but cannot be generated using the conventional association mining technique over a one-year transaction period using a unique min_supp value.

In view of these limitations, a need exists for a system and method of association mining that considers the exhibition period of each individual transaction and provides an intelligent support calculation basis for each item, reducing process time and improving usability of results.

### SUMMARY OF THE INVENTION

It is therefore an object of the present invention to provide a system and method of mining association relationships to reduce process time and improve result usability. To achieve the above object, the present invention provides a system and method of association itemset analysis that considers the exhibition period of each individual transaction and provides an intelligent support calculation basis for each item.

According to the invention, the system includes two storage devices, and an association analysis unit. One storage device stores a transaction record, and the other stores a minimal support (denoted as min_supp) value. All transaction records are partitioned according to the time scale, each comprising at least one transaction item.

The association analysis unit first calculates multiple weighted min_supp values using a weighted min_supp equation whose parameters comprise the sum of transaction records in a requisite partition and the min_supp value. Multiple itemsets are then generated among the transaction items and frequency is calculated for each itemset in a requisite partition. Finally, it is determined whether the frequency for each itemset exceeds the weighted min_supp value. The association analysis unit then generates itemsets for subsequent partitions, adding previously generated itemsets to the requisite partition, such that generations for each successive partition are incremental.

### BRIEF DESCRIPTION OF THE DRAWINGS

The present invention can be more fully understood by reading the subsequent detailed description and examples with references made to the accompanying drawings, wherein:

FIG. 1 is a diagram of the architecture of a system of association analysis according to the invention;

FIG. 2 is a diagram of an exemplary transaction record according to the invention;

FIG. 3 is a diagram of exemplary P₁ partition transactions according to the invention;

FIG. 4 is a diagram of exemplary P2 partition transactions according to the invention;

FIG. 5 is a diagram of exemplary P3 partition transactions according to the invention;

FIG. 6 is a flowchart showing a method of the association analysis according to the invention;

FIG. 7 is a diagram of a storage medium for storing a computer program providing the method of the association analysis according to the invention.

### DETAILED DESCRIPTION OF THE INVENTION

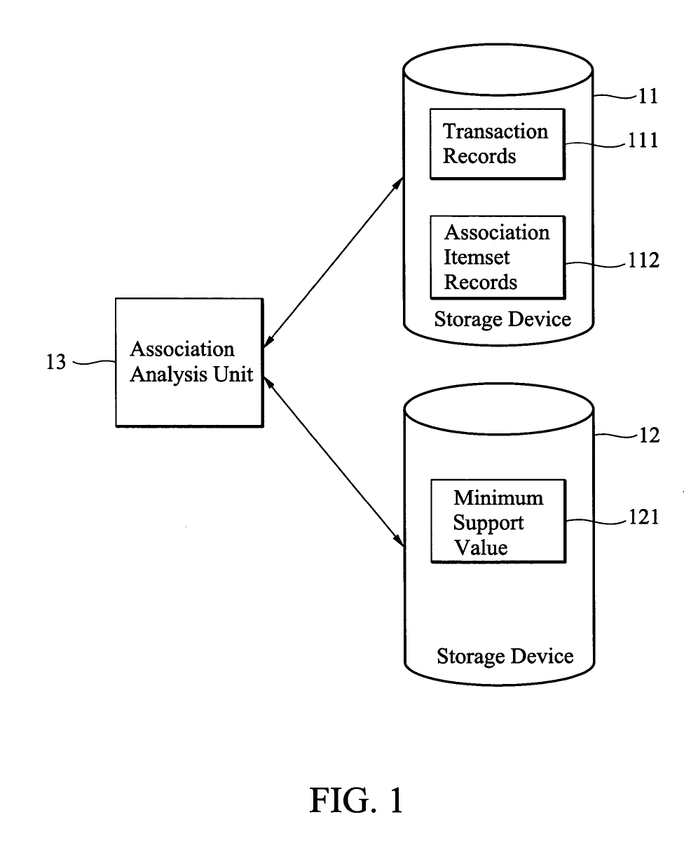

FIG. 1 is a diagram of the architecture of a system of association analysis according to the invention. The system includes storage devices 11, 12, and an association analysis unit 13. The storage device 11 stores multiple transaction records 111 and association itemset records 112. In addition, the storage device 12 stores a minimum support value (denoted as min_supp).

The storage device 11 can be implemented in a relational database or an object database. The implementation of the transaction records 111 or association itemset records 112 described above is not limited to a single table, but also to multiple related tables. Contrary to the conventional transaction records, the transaction records 111 are partitioned according to the definition of time scale. A transaction record 111 preferably comprises three fields, partition identity, transaction identity, and items, the transaction identity field being a primary key used to identify the record, the items field storing at least one transaction item. An itemset record 112 stores the results of the association analysis, both temporary and final, preferably comprising itemset, initiated partition, and frequency value fields. Consistent with the scope and spirit of the invention, additional or. different fields may be provided.

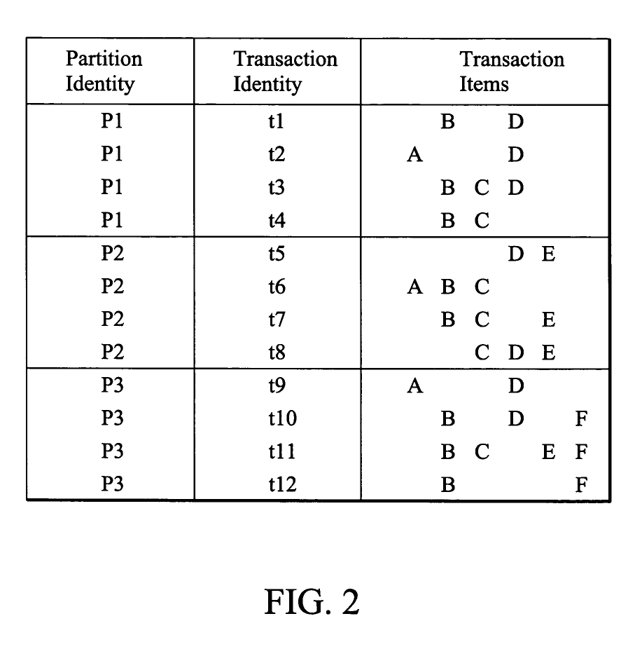

FIG. 2 is a diagram of an exemplary transaction record according to the invention. The transaction record 111 contains twelve records, ranging from t1 to t12, comprising partitions with transactions of t1 to t4, t5 to t8 and t9 to t12 respectively, each transaction having at least two items, which together form an itemset. For example, the transaction of t1 indicates association of B and D.

The storage device 12 can be implemented in relational database, an object database, a file, or reside in a constant of program code storing a min_supp. In the embodiment, the minimum support is assumed to be min_supp=30%.

The association analysis unit 13 can be implemented in a database system, data warehouse system, data mining system or other data processing system. The association analysis unit 13 employs a progressive filtering scheme in each partition to deal with the candidate itemset generation and process one partition at a time. Specifically, a progressive candidate set of itemsets is composed of two types of candidate itemsets, candidate itemsets carried over from the previous progressive candidate set in the previous phase, remaining as candidate itemsets after the current partition is considered, and referred to as type a candidate itemsets, and candidate itemsets not originally in the progressive candidate set in the previous phase but newly identified after taking only the current data partition into account, are referred to as type β candidate itemsets. According to the invention, the cumulative data of the prior phases is selectively carried over toward the generation of candidate itemsets in subsequent phases.

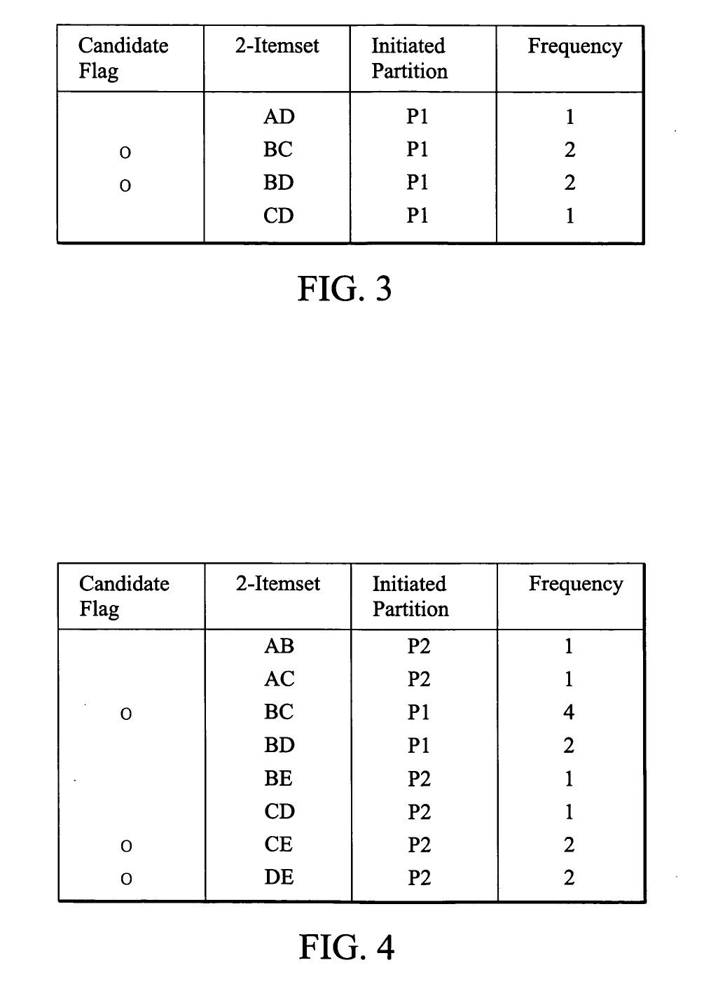

FIG. 3 is a diagram of exemplary P₁ partition transactions according to the invention. In phase 1, the association analysis unit 13 reads 4 transactions of the partition P1 as shown in FIG. 3, and subsequently generates 2-itemsets {AD,BC,BD,CD} as shown in FIG. 4, then calculates the frequency of each 2-itemset and records initiated partitions to P1.

The association analysis unit 13 reads min_supp value 121 from the storage device 12 to calculate weighted min_supp value of P1. Equation (1) shows the formula for calculating weighted min_supp value of P1.
min_supp(P1)=┌N(P1)×min_supp┐, Equation (1):
where min_supp(P1) is the weighted min_supp value of P1 and N(P1) is the sum of transactions in P1. Since there are four transactions in P1, the weighted min_supp value is min_supp(P1)=┌0.3×4┐=2. Such a weighted minimum support is referred to as the filtering threshold. Itemsets with frequencies less than the filtering threshold are removed. Thus, as shown in FIG. 3, only {BC,CD}, marked by “O”, remain as candidate itemsets (of type β in this phase since they are newly generated) whose information is recorded in itemset record 112 and then carried over to the next phase P2 for subsequent processing.

FIG. 4 is a diagram of exemplary P2 partition transactions according to the invention. In phase 2, the association analysis unit 13 reads itemset record 112 to retrieve 2-itemsets {BC,BD} as type α candidate itemsets. After that, it subsequently scans partition P2 as shown in FIG. 2, generates 2-itemsets {AB,AC,BE,CD,CE,DE} except type α candidate itemsets, and records the initiated partitions P2. Frequency of both type α and type β candidate itemsets in both partitions P1 and P2 is then calculated.

The association analysis unit 13 reads min_supp value 121 from the storage device 12 to respectively calculate weighted min_supp value of P1&P2 and P2. Equation (2) shows the formula for calculating weighted min_supp value of P1&P2. Equation (3) shows the formula for calculating weighted min_supp value of P2.
min_supp(P1&P2)=┌(N(P1)+N(P2))×min_supp┐, Equation (2):
where min_supp(P1&P2) is the weighted min_supp value of P1&P2, N(P1) is the sum of transactions in P1 and N(P2) is the sum of transactions in P2.
min_supp(P2)=┌N(P2)×min_supp┐; Equation (3):
where min_supp(P2) is the weighted min_supp value of P2 and N(P2) is the sum of transactions in P2.

The filtering threshold of itemsets carried over from the previous phase is min_supp(P1&P2)=┌(4+4)×0.3┐=3 and that of newly identified candidate itemsets is min_supp(P2)=┌4*0.3┐=2.

Itemsets with frequencies less than the filtering threshold are removed. Thus, as shown in FIG. 4, only {BC,CE,DE}, marked by “O”, remain as candidate itemsets, wherein one is of α type and two β type, whose information is recorded in itemset record 112 and then carried over to the next phase P2 for subsequent process.

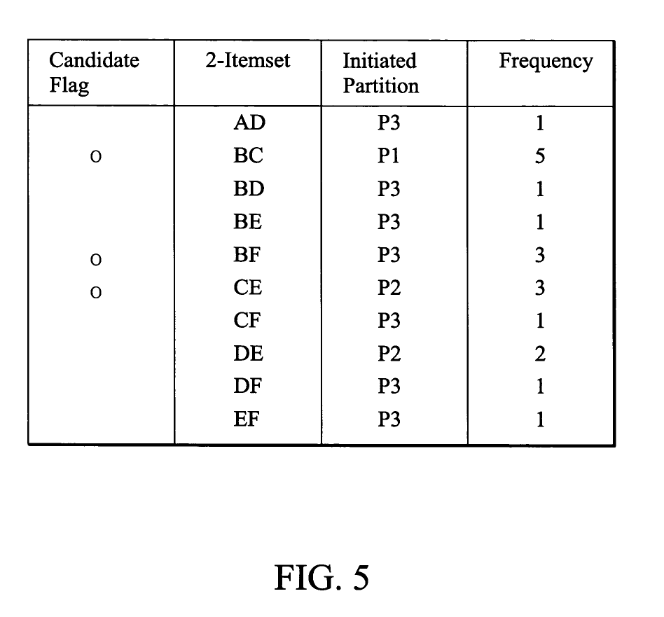

FIG. 5 is a diagram of exemplary P3 partition transactions according to the invention. In phase 3, the association analysis unit 13 reads itemset record 112 to retrieve 2-itemsets {BC,CE,DE} as type α candidate itemsets. After that, it subsequently scans partition P3 as shown in FIG. 2, generates 2-itemsets {AD,BD,BE,BF,CF,DF,EF} except type α candidate itemsets, and records the initiated partitions P3. Frequency of both type α and type β candidate itemsets in partitions P1, P2 and P3 is then calculated.

The association analysis unit 13 reads min_supp value 121 from the storage device 12 to respectively calculate weighted min_supp value of P1&P2&P3, P2&P3 and P3. Equation (4) shows the formula for calculating weighted min_supp value of P1&P2&P3. Equation (5) shows the formula for calculating weighted min_supp value of P2&P3. Equation (6) shows the formula for calculating weighted min_supp value of P3.
min_supp(P1&P2&P3)=┌(N(P1)+N(P2)+N(P3))×min_supp┐, Equation (4):
where min_supp(P1&P2&P3) is the weighted min_supp value of P1&P2&P3, N(P1) is the sum of transactions in P1, N(P2) is the sum of transactions in P2 and N(P3) is the sum of transactions in P3.
min_supp(P2&P3)=┌(N(P2)+N(P3))×min_supp┐, Equation (5):
where min_supp(P2&P3) is the weighted min_supp value of P2&P3, N(P2) is the sum of transactions in P2 and N(P3) is the sum of transactions in P3.
min_supp(P3)=┌N(P3)×min_supp┐, Equation (6):
where min_supp(P3) is the weighted min_supp value of P3 and N(P3) is the sum of transactions in P3.

The filtering thresholds of itemsets carried over from the previous phase are min_supp(P1&P2&P3)=┌(4+4+4)×0.3┐=4 and min_supp(P2&P3)=┌(4+4)×0.3┐=3 and that of newly identified candidate itemsets is min_supp(P3)=┌4*0.3┐=2.

Itemsets with frequencies less than the filtering threshold are removed. Thus, as shown in FIG. 5, only {BC,CE,BF}, marked by “O”, remain as final candidate itemsets, whose information is recorded in itemset record 112.

Although 2-itemset is used in the embodiment, the present invention is also applicable to 3-itemset, 4-itemset, or k-itemset, where k is an integer.

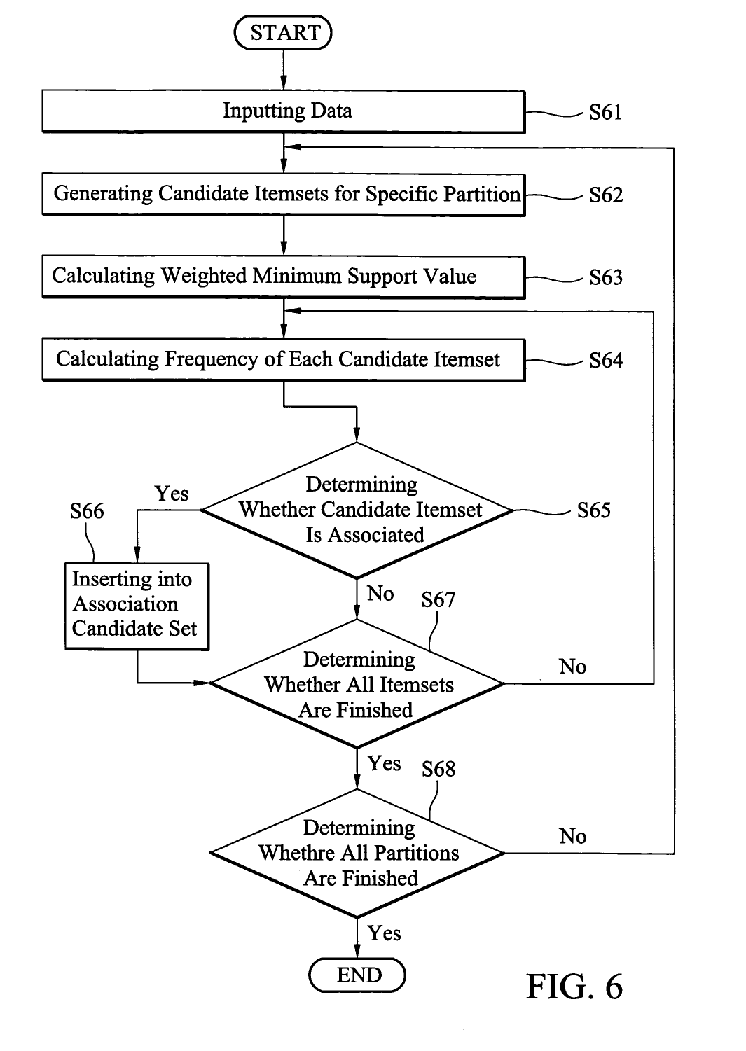

FIG. 6 is a flowchart showing a method of the association analysis according to the invention.

The association analysis unit 13, first, in step S61, inputs a partition of the transaction record 111 as shown in FIG. 2, and itemset record 112 from the storage device 11, and inputs the min_supp value 121 from the storage device 12.

Then, in step S62, 2-itemsets are acquired as candidate itemsets from the transaction record 111 and the itemset record 113. Type α candidate itemsets and initiated partitions thereof are read from the itemset record 113, and type β candidate itemsets are generated from the transaction record 111.

In step S63, the weighted minimum support of each associated partition is calculated. For example, the weighted minimum support of P1&P2 is calculated by equations (2) and (3) respectively and partition P2 is calculated in process. In addition, when the partition P3 is in process, the weighted minimum support of P3, P2&P3 and P1&P2&P3 must be calculated.

In step S64, frequency of a candidate itemset generated in step S62 is calculated by the summarizing the occurrence in corresponding partitions.

In step S65, it is determined whether the frequency exceeds the corresponding filtering threshold. In step S66, candidate itemsets with frequency exceeding the corresponding filtering threshold are inserted into the result.

In step S67, it is determined whether any candidate itemset of the current partition remain unprocessed. If so, the process proceeds to step S63 for continuous reading of subsequent candidate itemsets, otherwise, the process proceeds to step S68.

In step S68, it is determined whether any partitions remain unprocessed, if so, the process proceeds to step S61 to continually read next partition, otherwise, the process is complete.

The system and method of association mining of the present invention considers the exhibition period of each individual transaction and provides an intelligent support calculation basis for each item, reducing process time and improving result usability.

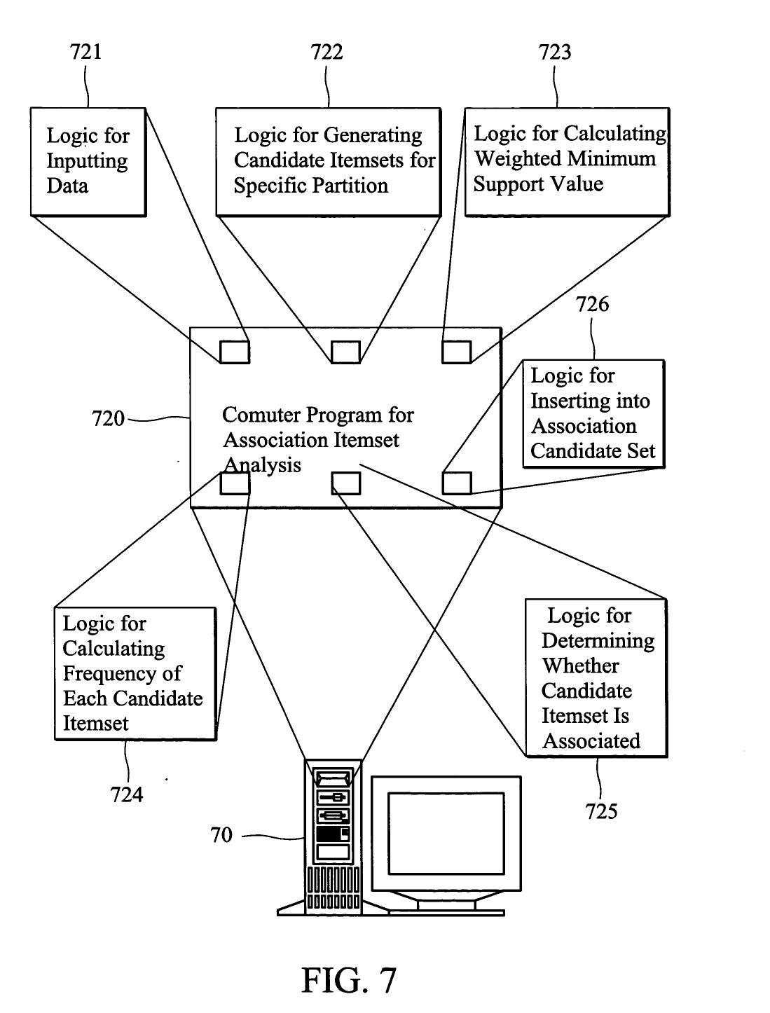

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits. The storage medium is shown in FIG. 7.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. A system of association itemset analysis, comprising:
a storage device capable of storing a plurality of first transaction records corresponding to a first time scale, a plurality of second transaction records corresponding to a second time scale, an initiated minimum support (min_supp) value and a plurality of itemset records, wherein each first transaction record or each second transaction record comprises a transaction item, the itemset record comprising a first association itemset and a first value thereof, the first association itemset comprising the transaction items in the first transaction record, the first value is frequency of the first association itemset in the first transaction record; and
an association analysis unit, coupled to the storage device, configured to input the itemset record from the storage device, calculate a second value by adding the first value and frequency of the first association itemset occurring in the second transaction record, generate a second association itemset and a third value thereof according to the second transaction record, the third value is frequency of the second association itemset in the second transaction record, calculated by a first min_supp value and a second min_supp value according to the initiated min_supp value and corresponding sum of transaction records, insert the first association itemset whose the second value exceeds the first min_supp value into a candidate set and inserting the second association itemset whose third value exceeds the second min_supp value into the candidate set.

2. The system as claimed in claim 1 wherein the first min_supp value is calculated by multiplying the initiated min_supp value by the sum of the first transaction records and the second transaction records.

3. The system as claimed in claim 2 wherein the second min_supp value is calculated by multiplying the initiated min_supp value by the sum of the second transaction records.

4. The system as claimed in claim 1 wherein each association itemset includes at least two transaction items.

5. The system as claimed in claim 1 wherein the association analysis unit further writes the first association itemsets, the second association itemsets and corresponding values within the candidate set to the itemset records for successive partition analysis.

6. A method of association itemset analysis, the method comprising using a computer to perform the steps of:
inputting a transaction record corresponding to the current partition, wherein the transaction record comprises at least one transaction item;
inputting an itemset record, wherein the itemset record comprises a first association itemset and a first value, the first association itemset comprises the transaction item, the first value is a frequency of the first association itemset occurring in antecedent partitions;
calculating a second value by adding the first value and frequency of the first association itemset occurring in the current partition;
generating a second association itemset and a third value corresponding to the transaction record, wherein the third value is frequency of the second association itemset occurring in the current partition;
calculating a first min_supp value and a second min_supp value according to an initiated min_supp value;
inserting the first association itemset into a candidate set if the second value exceeds the first min_supp value; and
inserting the second association itemset into the candidate set if the third value exceeds the second min_supp value.

7. The method as claimed in claim 6 wherein the first min_supp value is calculated by multiplying the initiated min_supp value by the sum of transaction records in preceding and current partitions.

8. The method as claimed in claim 7 wherein the second min_supp value is calculated by multiplying the initiated min_supp value by the sum of transaction records in the current partition.

9. The method as claimed in claim 6 wherein each association itemset includes at least two transaction items.

10. The method as claimed in claim 6 further comprising a step of writing the first association itemsets, the second association itemsets and corresponding values within the candidate set to the itemset records for successive partition analysis.

11. A storage medium for storing a computer program providing a method of association itemset analysis, the method comprising using a computer to perform the steps of:
inputting a transaction record corresponding to current partition, wherein the transaction record comprises at least one transaction item;
inputting a itemset record, wherein the itemset record comprises a first association itemset and a first value, the first association itemset comprises the transaction item, the first value is frequency of the first association itemset occurring in the antecedent partitions;
calculating a second value by adding the first value and frequency of the first association itemset occurring in the current partition;
generating a second association itemset and a third value corresponding to the transaction record, wherein the third value is frequency of the second association itemset occurring in the current partition;
calculating a first min_supp value and a second min_supp value according to an initiated min_supp value;
inserting the first association itemset into a candidate set if the second value exceeds the first min_supp value; and
inserting the second association itemset into the candidate set if the third value exceeds the second min_supp value.

12. The method as claimed in claim 11 wherein the first min_supp value is calculated by multiplying the initiated min_supp value by the sum of transaction records in preceding and current partitions.

13. The method as claimed in claim 12 wherein the second min_supp value is calculated by multiplying the initiated min_supp value by the sum of transaction records in the current partition.

14. The method as claimed in claim 11 wherein each association itemset includes at least two transaction items.

15. The method as claimed in claim 11 further comprising a step of writing the first association itemsets, the second association itemsets and corresponding values within the candidate set to the itemset records for successive partition analysis.
